(19) United States
(12) Patent Application Publication
(10) Pub. No.: US 2025/0246174 A1
(43) Pub. Date: Jul. 31, 2025

(54) SOUNDPROOFING COVER

(71) Applicant: TOYOTA JIDOSHA KABUSHIKI KAISHA, Toyota-shi (JP)

(72) Inventors: Yukari SUMIE, Toyota-shi (JP); Masayuki OKANO, Toyota-shi (JP)

(73) Assignee: TOYOTA JIDOSHA KABUSHIKI KAISHA, Toyota-shi (JP)

(21) Appl. No.: 18/926,309

(22) Filed: Oct. 25, 2024

(30) Foreign Application Priority Data
Jan. 31, 2024 (JP) 2024-012895

(51) Int. Cl. G10K 11/16

(52) U.S. Cl. CPC G10K 11/16

(57) ABSTRACT

A soundproofing cover includes a first cover portion, a second cover portion in which a second outer edge portion is abuttable against a first outer edge portion in a state where the first notch portion and the second notch portion are opposed to each other, the first cover portion and the second cover portion are connected, and a hinge portion for closing the first notch portion and the second notch portion that are opposed to each other is provided, the hinge portion, When the second cover portion is opened to a predetermined angle of less than 180 degrees with respect to the first cover portion, the central region in the circumferential direction of the first arcuate outer edge portion and the second arcuate outer edge portion is deformed into a convex shape protruding inward of the first cover portion and the second cover portion.

### CROSS-REFERENCE TO RELATED APPLICATION

This application claims priority to Japanese Patent Application No. 2024-012895 filed on Jan. 31, 2024, incorporated herein by reference in its entirety.

### BACKGROUND

### 1. Technical Field

The disclosure relates to a soundproofing cover.

### 2. Description of Related Art

Soundproofing covers having a pair of cover portions linked by a hinge portion formed of an integral hinge, and formed so as to cover the entire outer face of a noise source, are conventionally known (e.g., see Japanese Unexamined Patent Application Publication No. 2021-170086 (JP 2021-170086 A)).

### SUMMARY

However, in the case of a soundproofing cover linked by a hinge portion formed of an integral hinge, it is difficult to keep one cover portion in an open state at a predetermined angle of less than 180 degrees with respect to the other cover portion. That is to say, in a case of the soundproofing cover having the above-described configuration, the one cover portion is unsteady with respect to the other cover portion and is not stable, and accordingly may be difficult to handle.

Accordingly, an object of the disclosure is to provide a soundproofing cover that is capable of keeping a second cover portion in an open state at a predetermined angle of less than 180 degrees with respect to a first cover portion.

In order to achieve the above object, a soundproofing cover according to a first aspect of the disclosure includes
a first cover portion that is fashioned in a shape of a housing, and of which a part of a first outer edge portion makes up a first arcuate outer edge portion, the first arcuate outer edge portion including a first notch portion,
a second cover portion that is fashioned in a shape of a housing, and of which a part of a second outer edge portion makes up a second arcuate outer edge portion, the second arcuate outer edge portion including a second notch portion, in which the second outer edge portion is abuttable against the first outer edge portion in a state in which the first notch portion and the second notch portion face each other, and
a hinge portion that is elastically deformable, linking the first cover portion and the second cover portion, and also closing off the first notch portion and the second notch portion facing each other, in which
the hinge portion is configured such that, when the second cover portion is opened to a predetermined angle of less than 180 degrees with respect to the first cover portion, a middle region in a circumferential direction of at least the first arcuate outer edge portion and the second arcuate outer edge portion is deformed into a protruding shape that protrudes to an inward side of the first cover portion and the second cover portion.

According to the disclosure of the first aspect, a portion of the first outer edge portion of the first cover portion of the housing shape is the first arcuate outer edge portion, the first notch portion is formed in the first arcuate outer edge portion, a portion of the second outer edge portion of the second cover portion of the housing shape is the second arcuate outer edge portion, and the second notch portion is formed in the second arcuate outer edge portion. Also, the second outer edge portion is abuttable to the first outer edge portion in a state in which the first notch portion and the second notch portion face each other, and the hinge portion that is elastically deformable, and that links the first cover portion and the second cover portion, closes off the first notch portion and the second notch portion facing each other.

Here, the hinge portion is configured such that, when opening the second cover portion to a predetermined angle of less than 180 degrees with respect to the first cover portion, the middle region in the circumferential direction of at least the first arcuate outer edge portion and the second arcuate outer edge portion is deformed into a protruding shape that protrudes to the inward side of the first cover portion and the second cover portion. This enables the second cover portion to be kept open at a predetermined angle of less than 180 degrees with respect to the first cover portion, thereby facilitating handling of the soundproofing cover.

Also, the soundproofing cover according to a second aspect of the disclosure is the soundproofing cover according to the first aspect, in which, when opening the second cover portion to the predetermined angle of less than 180 degrees with respect to the first cover portion, an end portion of the hinge portion in the circumferential direction of the first arcuate outer edge portion and the second arcuate outer edge portion assumes an arc shape.

According to the disclosure of the second aspect, when the second cover portion is opened to a predetermined angle of less than 180 degrees with respect to the first cover portion, the end portion in the circumferential direction of the first arcuate outer edge portion and the second arcuate outer edge portion of the hinge portion form an arc shape. Accordingly, when the second cover portion is opened to a predetermined angle of less than 180 degrees with respect to the first cover portion, the second cover portion is easily held at a predetermined angle of less than 180 degrees with respect to the first cover portion, as compared with when the end portion in the circumferential direction of the first arcuate outer edge portion and the second arcuate outer edge portion of the hinge portion forms a straight line. Note that the “arcuate shape” in the disclosure also includes substantially arcuate shapes.

Also, the soundproofing cover according to a third aspect of the disclosure is the soundproofing cover according to the first aspect, in which the hinge portion is configured such that, when the second cover portion is closed with respect to the first cover portion, at least the middle region in the circumferential direction of the first arcuate outer edge portion and the second arcuate outer edge portion is deformed into a protruding shape that protrudes to an outward side from the first cover portion and the second cover portion.

According to the disclosure of the third aspect, when the second cover portion is closed with respect to the first cover portion, the middle region in the circumferential direction of at least the first arcuate outer edge portion and the second arcuate outer edge portion of the hinge portion is configured to be deformed into a protruding shape that protrudes to the outward side from the first cover portion and the second cover portion. This enables the second cover portion to be kept in a closed state with respect to the first cover portion.

Also, the soundproofing cover according to a fourth aspect of the disclosure is the soundproofing cover according to any one of the first to third aspects, in which a plate thickness of the hinge portion is constant.

According to the disclosure of the fourth aspect, the plate thickness of the hinge portion is constant. Accordingly, even when the second cover portion is repeatedly opened and closed with respect to the first cover portion, cracks do not readily occur in the hinge portion, as compared with, for example, a case in which the plate thickness of the middle portion of the hinge portion is made thinner than the plate thickness of other portions.

As described above, according to the disclosure, the second cover portion can be kept in an open state at a predetermined angle of less than 180 degrees with respect to the first cover portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic plan view showing a closed condition of a soundproofing cover according to an embodiment of the present disclosure;

FIG. 1B is a schematic plan view showing an open condition of the soundproofing covering according to this embodiment;

FIG. 1C is a schematic side view illustrating an enlarged view of a hinge portion in an open condition of a soundproofing covering according to an embodiment of the present disclosure;

FIG. 2A is a schematic cross-sectional view taken along a IIA-IIA line in FIG. 1A;

FIG. 2B is a schematic cross-sectional view taken along a IIB-IIB line in FIG. 1A;

FIG. 3A is a schematic cross-sectional view taken along a IIIA-IIIA line in FIG. 1B;

FIG. 3B is a schematic cross-sectional view taken along a IIIB-IIIB line in FIG. 1B;

FIG. 4 is a schematic perspective view showing an enlarged hinge portion in an open state of the soundproofing cover according to the present embodiment;

FIG. 5A is a schematic perspective view showing an enlarged view of a hinge portion when a soundproofing cover according to the present embodiment is closed;

FIG. 5B is a schematic perspective view illustrating an enlarged view of a hinge portion when a soundproofing cover according to an embodiment is closed;

FIG. 5C is a schematic perspective view illustrating an enlarged view of a hinge portion when a soundproofing cover according to an embodiment is closed;

FIG. 5D is a schematic perspective view illustrating an enlarged view of a hinge portion when a soundproofing cover according to an embodiment is closed;

FIG. 6A is a schematic perspective view showing an enlarged view of a harness drawn out from the inside of the soundproofing cover according to this embodiment; and

FIG. 6B is a schematic perspective view showing an enlarged condition of the harness when closing the soundproofing cover according to the present embodiment.

### DETAILED DESCRIPTION OF EMBODIMENTS

Hereinafter, an embodiment according to the present disclosure will be described in detail with reference to the drawings. For convenience of explanation, the upper and lower portions of the soundproofing cover 10 are defined as follows. That is, the first cover portion of the soundproofing cover 10 is referred to as a lower cover portion 20, and the second cover portion of the soundproofing cover 10 is referred to as an upper cover portion 30.

Further, in the present embodiment, each of the lower cover portion 20 and the upper cover portion 30 has a substantially hemispherical housing shape. However, as long as the lower arcuate outer edge portion 26A as the first arcuate outer edge portion and the upper arcuate outer edge portion 36A as the second arcuate outer edge portion, which will be described later, are formed in a substantially arcuate shape in bottom view and plan view, respectively, the shapes of the other portions in the soundproofing cover 10 are not limited to the illustrated shapes.

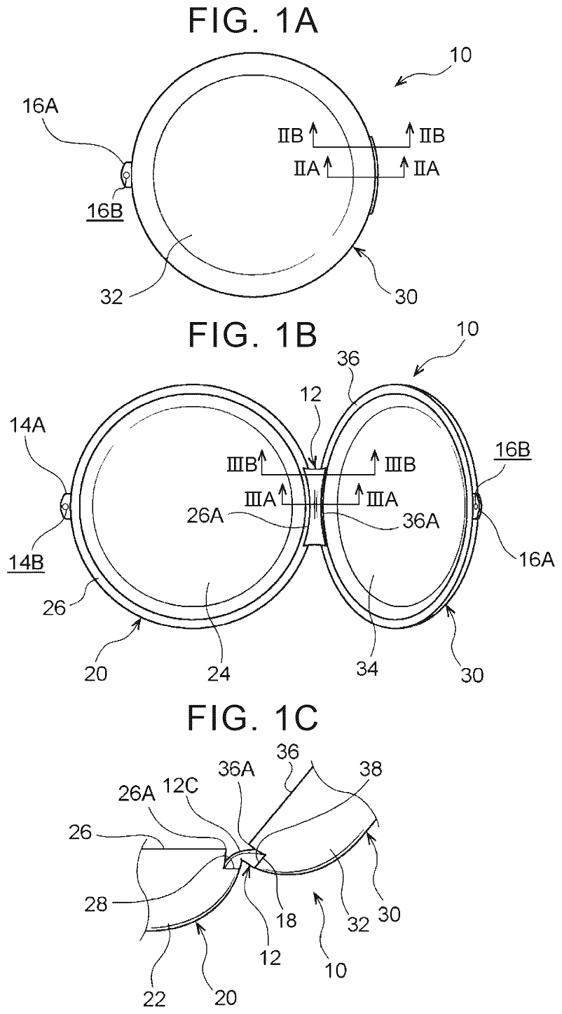

As shown in FIGS. 1A to 4, the soundproofing cover 10 according to the present embodiment includes a substantially hemispherical lower cover portion 20, a substantially hemispherical upper cover portion 30, and a hinge portion 12 connecting the lower cover portion 20 and the upper cover portion 30. The hinge portion 12 is made of a resin having a constant plate thickness, and is configured to be elastically deformable.

Examples of the resin material constituting the hinge portion 12 include film-based materials such as polyethylene (PE), polyethylene terephthalate (PET), polypropylene (PP), polyvinyl chloride (PVC), and ethylene propylene diene rubber (EPDM). In the present embodiment, the hinge portion 12 extends so as to serve as a base material of the lower cover portion 20 and the upper cover portion 30.

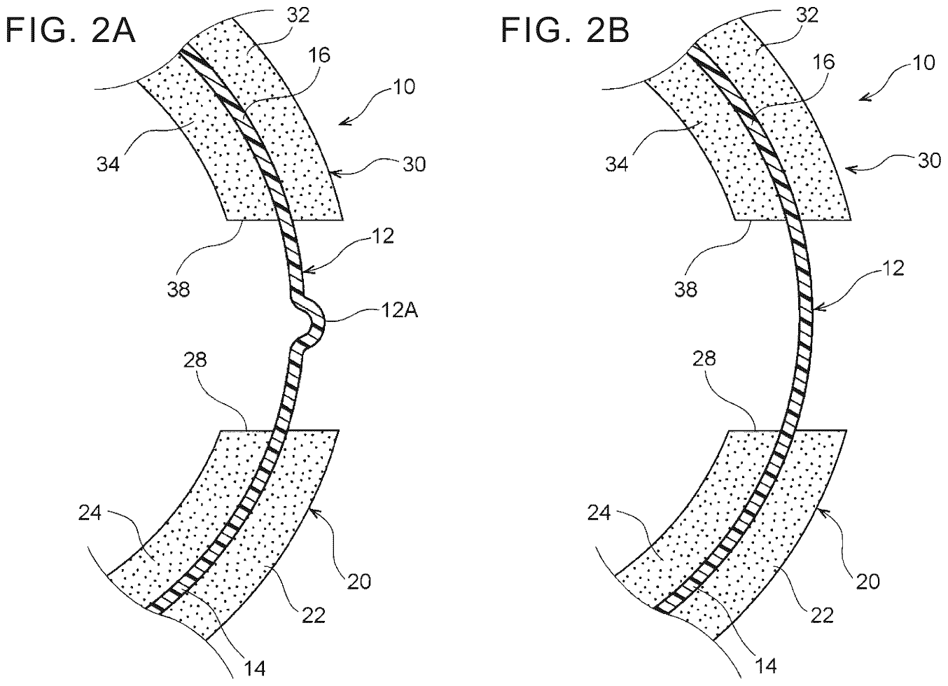

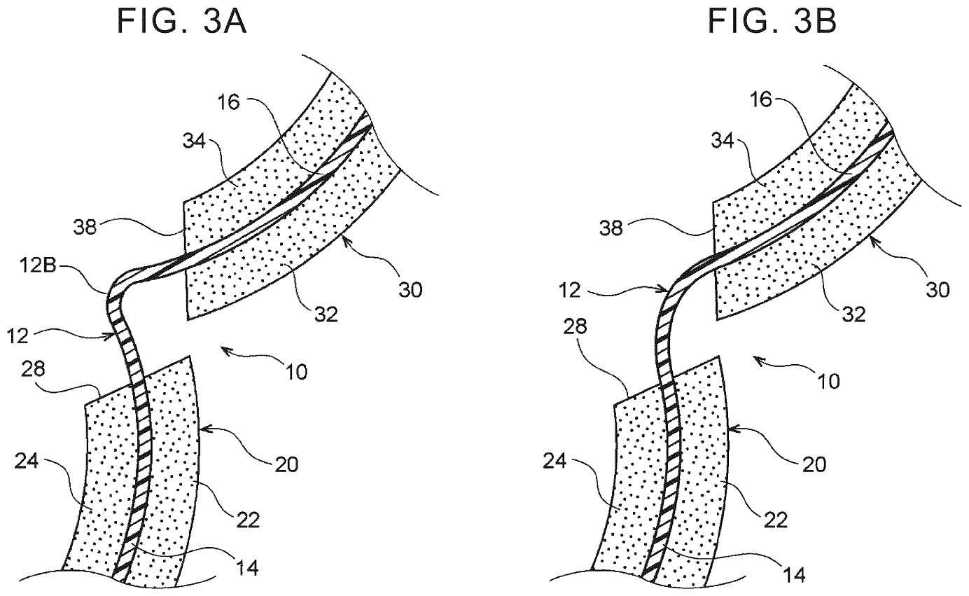

That is, in the lower cover portion 20, the outer layer portion 22 and the inner layer portion 24 are attached to both surfaces of the lower base portion 14 (refer to FIGS. 2A to 3B) formed in a substantially hemispherical shape integral with the hinge portion 12 by an adhesive or the like. Thus, the lower cover portion 20 is formed in a substantially hemispherical shape. The outer layer portion 22 and the inner layer portion 24 are made of a porous material having sound absorption properties such as felt or urethane.

Similarly, in the upper cover portion 30, the outer layer portion 32 and the inner layer portion 34 are adhered to both surfaces of the upper base portion 16 (refer to FIGS. 2A to 3B) formed in a substantially hemispherical shape integral with the hinge portion 12 by an adhesive or the like. Thus, the upper cover portion 30 is formed in a substantially hemispherical shape. The outer layer portion 32 and the inner layer portion 34 are made of a porous material having sound absorption properties such as felt or urethane.

Further, the lower flange portion 14A and the upper flange portion 16A which are substantially rectangular in plan view are integrally formed on the lower base portion 14 and the upper base portion 16, respectively, on the side opposite to the hinge portion 12 by 180 degrees. An upper outer edge portion 36 serving as a second outer edge portion of the upper cover portion 30 abuts against (abuts on) a lower outer edge portion 26 serving as a first outer edge portion of the lower cover portion 20. Thus, when the soundproofing cover 10 is closed, the upper flange portion 16A is superimposed on the lower flange portion 14A.

Through-holes 14B, 16B are formed in the lower flange portion 14A and the upper flange portion 16A to penetrate each other. When a fixing clip (not shown) or the like is attached to the through-hole 14B, 16B, the soundproofing cover 10 is closed so as not to be opened while the lower outer edge portion 26 of the lower cover portion 20 and the upper outer edge portion 36 of the upper cover portion 30 are in close contact with each other.

In the following description, the lower flange portion 14A and the upper flange portion 16A side are referred to as the front side of the soundproofing cover 10, the hinge portion 12 side of the soundproofing cover 10 is referred to as the rear side, and when viewed from the rear side, it is referred to as the rear view of the soundproofing cover 10. Then, a direction orthogonal to the vertical direction and the front-rear direction of the soundproofing cover 10 is defined as a left-right direction of the soundproofing cover 10, and a case viewed from the left-right direction is defined as a side view.

A rear portion (part) of the lower outer edge portion 26 of the lower cover portion 20, which is the hinge portion 12 side, is a lower arcuate outer edge portion 26A as a first arcuate outer edge portion, and a lower notch portion 28 as a first notch portion is formed on the lower arcuate outer edge portion 26A. The lower notch portion 28 is formed in a substantially rectangular shape in which a circumferential direction of the lower arcuate outer edge portion 26A is a longitudinal direction in a rear view.

Similarly, a rear portion (part) of the upper outer edge portion 36 of the upper cover portion 30, which is the hinge portion 12 side, is an upper arcuate outer edge portion 36A as a second arcuate outer edge portion, and an upper notch portion 38 as a second notch portion is formed on the upper arcuate outer edge portion 36A. The upper notch portion 38 is also formed in a substantially rectangular shape in which a circumferential direction of the upper arcuate outer edge portion 36A is a longitudinal direction in a rear view.

The lower notch portion 28 and the upper notch portion 38 face each other vertically when the upper outer edge portion 36 abuts against the lower outer edge portion 26. The hinge portion 12 is exposed from the notch portion 18 formed by the lower notch portion 28 and the upper notch portion 38 and having a substantially rectangular shape in the rear view. In other words, the hinge portion 12 connects the lower cover portion 20 and the upper cover portion 30, and closes the notch portion 18 having a substantially rectangular shape in the rear view formed by the lower notch portion 28 and the upper notch portion 38 which are opposed to each other.

Further, when the upper cover portion 30 is closed with respect to the lower cover portion 20, the hinge portion 12 is configured such that at least a predetermined central region (a region serving as a center in the vertical direction) in the circumferential direction is deformed into a convex shape protruding outward from the lower cover portion 20 and the upper cover portion 30. The circumferential direction is a circumferential direction of the lower arcuate outer edge portion 26A and the upper arcuate outer edge portion 36A. That is, at least in the central area of the hinge portion 12 at this time, the outer ridge portion 12A extending circumferentially is formed (see FIG. 2A).

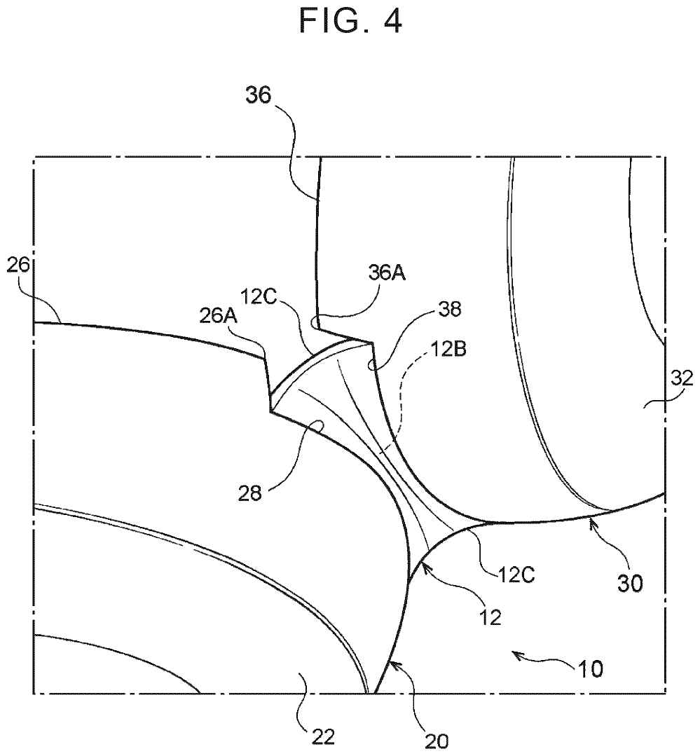

On the other hand, when the upper cover portion 30 is opened to a predetermined angle of less than 180 degrees with respect to the lower cover portion 20, the hinge portion 12 is configured such that at least a predetermined central region (a region serving as a center in the vertical direction) in the circumferential direction is deformed into a convex shape protruding inwardly of the lower cover portion 20 and the upper cover portion 30 (protruding in a warped manner). The circumferential direction is a circumferential direction of the lower arcuate outer edge portion 26A and the upper arcuate outer edge portion 36A. That is, at least in the central area of the hinge portion 12 at this time, the inner ridge portion 12B extending circumferentially is formed (see FIGS. 3A and 4).

The shape-holding force of the inner ridge portion 12B keeps the upper cover portion 30 open at a predetermined angle of less than 180 degrees with respect to the lower cover portion 20. Then, the reversal operation of the hinge portion 12 when the outer ridge portion 12A is formed and the inner ridge portion 12B is formed causes a clicking feeling when the upper cover portion 30 is opened and closed with respect to the lower cover portion 20.

Further, the hinge portion 12 is configured such that, when the upper cover portion 30 is opened to a predetermined angle of less than 180 degrees with respect to the lower cover portion 20, the end portion 12C thereof in the circumferential direction forms a substantially circular arc shape that is convex inward in a side view (see FIGS. 1C and 4). The circumferential direction is a circumferential direction of the lower arcuate outer edge portion 26A and the upper arcuate outer edge portion 36A.

Next, the operation of the soundproofing cover 10 according to the present embodiment configured as described above will be described.

As described above, the rear portion (part) of the lower outer edge portion 26 of the lower cover portion 20 is formed as the lower arcuate outer edge portion 26A, and the lower notch portion 28 is formed on the lower arcuate outer edge portion 26A. Similarly, a rear portion (part) of the upper outer edge portion 36 of the upper cover portion 30 is an upper arcuate outer edge portion 36A, and an upper notch portion 38 is formed on the upper arcuate outer edge portion 36A.

The upper outer edge portion 36 is abuttable on the lower outer edge portion 26 in a state where the lower notch portion 28 and the upper notch portion 38 face each other. An elastically deformable hinge portion 12 connecting the lower cover portion 20 and the upper cover portion 30 closes the opposed lower notch portion 28 and the upper notch portion 38. That is, the hinge portion 12 closes the notch portion 18.

Here, when the upper cover portion 30 is opened to a predetermined angle of less than 180 degrees with respect to the lower cover portion 20, the hinge portion 12 is deformed into a convex shape in which at least a central region in the circumferential direction protrudes inward of the lower cover portion 20 and the upper cover portion 30. That is, an inner ridge portion 12B extending circumferentially is formed at least in the central area of the hinge portion 12. Therefore, the upper cover portion 30 can be maintained in an open state at a predetermined angle of less than 180 degrees with respect to the lower cover portion 20, and the soundproofing cover 10 can be easily handled, for example, when a plurality of soundproofing covers 10 are stacked and conveyed.

Further, in the soundproofing cover 10, when the upper cover portion 30 is opened to a predetermined angle of less than 180 degrees with respect to the lower cover portion 20, the end portion 12C of the hinge portion 12 in the circumferential direction forms a substantially arc shape in a side view. Therefore, when the upper cover portion 30 is opened to a predetermined angle of less than 180 degrees with respect to the lower cover portion 20, the upper cover portion 30 is easily held in a stable state at a predetermined angle of less than 180 degrees with respect to the lower cover portion 20 as compared with a case where the end portion of the hinge portion 12 in the circumferential direction forms a straight line, and is not wobbled.

On the other hand, in the soundproofing cover 10, when the upper cover portion 30 is closed with respect to the lower cover portion 20, the upper cover portion 30 may be pressed lightly (with a small force) in the closing direction. Thus, when covering a unit serving as a noise source such as a motor or a compressor (not shown), it is possible to easily perform the operation of closing the lower cover portion 20 and the upper cover portion 30 by aligning them with each other.

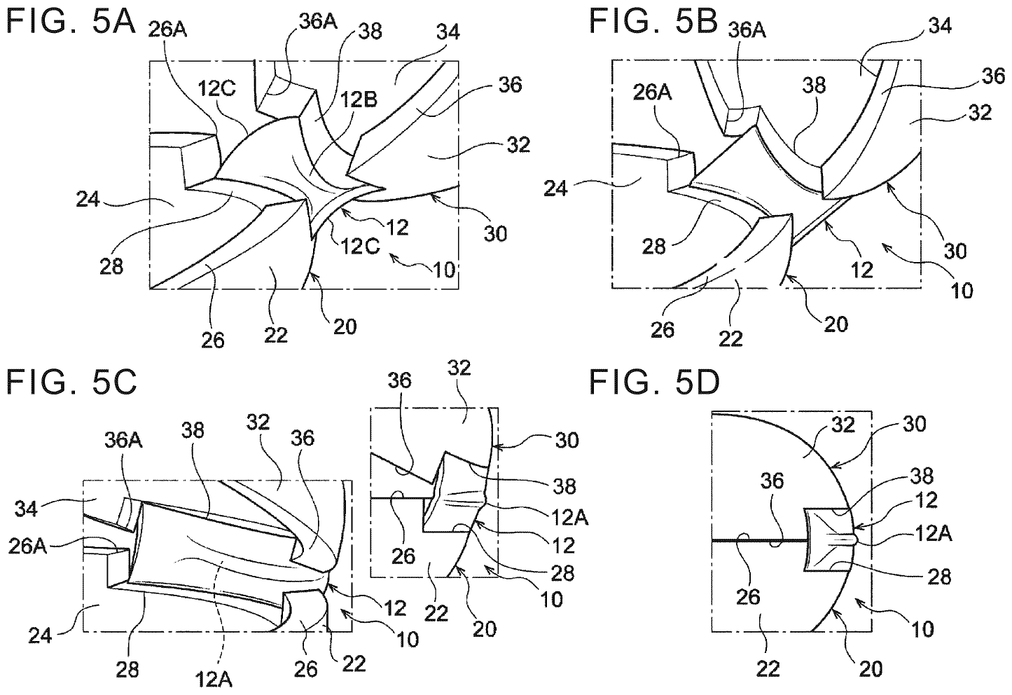

Specifically, as shown in FIGS. 5A to 5D, when the upper cover portion 30 is pushed toward closing with respect to the lower cover portion 20, the inner ridge portion 12B is reversed (warped). Then, at least a central region of the hinge portion 12 in the circumferential direction is deformed into a convex shape protruding outward from the lower cover portion 20 and the upper cover portion 30. That is, an outer ridge portion 12A extending circumferentially is formed at least in the central area of the hinge portion 12.

Since the upper cover portion 30 is automatically closed by the biasing force when reversing from the inner ridge portion 12B to the outer ridge portion 12A in the hinge portion 12, the lower cover portion 20 and the upper cover portion 30 can be easily positioned and closed as described above. The outer ridge portion 12A can keep the upper cover portion 30 closed with respect to the lower cover portion 20. Therefore, the fixing clip can be easily attached to the lower flange portion 14A and the upper flange portion 16A which are superimposed on each other.

In this way, the soundproofing cover 10 is closed (the lower outer edge portion 26 and the upper outer edge portion 36 are brought into close contact with each other), whereby it is suppressed that the sound generated from the unit serving as the noise source leaks to the outside of the soundproofing cover 10. In the soundproofing cover 10, the thickness of the hinge portion 12 is constant. Therefore, even if the upper cover portion 30 is repeatedly opened and closed with respect to the lower cover portion 20, cracks hardly occur in the hinge portion 12, as compared with, for example, a case where the thickness of the middle portion of the hinge portion 12 is formed to be thinner than the thickness of the other portions.

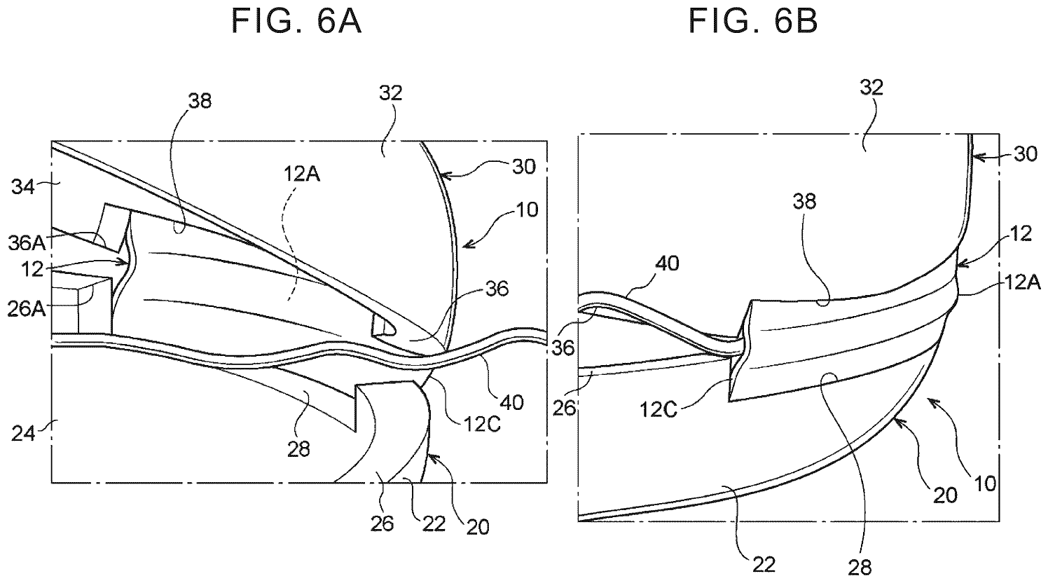

As shown in FIGS. 6A and 6B, a power-on harness 40 is connected to a unit serving as a noise source. The harness 40 can be pulled out to the outside of the soundproofing cover 10 from a gap between the end portion 12C in the circumferential direction of the hinge portion 12 and the end portion in the circumferential direction of the notch portion 18 (the lower notch portion 28 or the upper notch portion 38).

That is, in the soundproofing cover 10, the upper cover portion 30 can be closed (sealed) with respect to the lower cover portion 20 in a state where the harness 40 is pulled out from the gap. Therefore, it is not necessary to separately form a hole or the like for pulling out the harness 40 in the lower cover portion 20 or the upper cover portion 30. Therefore, the sealing property is better than that of a cover (not shown) that needs to form a hole portion for drawing out the harness, and the soundproof effect can be enhanced.

Further, the soundproofing cover 10, the lower cover portion 20 is configured by the outer layer portion 22 and the inner layer portion 24 made of resin is attached to both surfaces of the lower base portion 14 integral with the hinge portion 12. Further, the upper cover portion 30 is formed by attaching the resin outer layer portion 32 and the inner layer portion 34 to both surfaces of the upper base portion 16 integral with the hinge portion 12. Therefore, the rigidity of the lower cover portion 20 and the upper cover portion 30 can be secured, the number of components can be reduced, and the manufacturing cost can also be reduced.

Although the soundproofing cover 10 according to the present embodiment has been described above on the basis of the drawings, the soundproofing cover 10 according to the present embodiment is not limited to the illustrated one, and can be appropriately changed in design without departing from the gist of the present disclosure. For example, when the upper cover portion 30 is closed with respect to the lower cover portion 20, as long as the upper cover portion 30 can be maintained in a closed condition, the outer ridge portion 12A may not be formed in the hinge portion 12.

In addition, in the lower cover portion 20, one of the outer layer portion 22 and the inner layer portion 24 may be made of a resin having sound absorption performance. Similarly, the upper cover portion 30 may be made of a resin having sound absorbing performance, either the outer layer portion 32 or the inner layer portion 34. Further, even if the upper cover portion 30 is repeatedly opened and closed with respect to the lower cover portion 20, the plate thickness of the hinge portion 12 may not be constant as long as the hinge portion 12 has a configuration in which cracks are hardly generated.

What is claimed is:

1. A soundproofing cover comprising:
a first cover portion that is fashioned in a shape of a housing, and of which a part of a first outer edge portion makes up a first arcuate outer edge portion, the first arcuate outer edge portion including a first notch portion;
a second cover portion that is fashioned in a shape of a housing, and of which a part of a second outer edge portion makes up a second arcuate outer edge portion, the second arcuate outer edge portion including a second notch portion, in which the second outer edge portion is abuttable against the first outer edge portion in a state in which the first notch portion and the second notch portion face each other; and
a hinge portion that is elastically deformable, linking the first cover portion and the second cover portion, and also closing off the first notch portion and the second notch portion facing each other, in which
the hinge portion is configured such that, when the second cover portion is opened to a predetermined angle of less than 180 degrees with respect to the first cover portion, a middle region in a circumferential direction of at least the first arcuate outer edge portion and the second arcuate outer edge portion is deformed into a protruding shape that protrudes to an inward side of the first cover portion and the second cover portion.

2. The soundproofing cover according to claim 1, wherein when opening the second cover portion to the predetermined angle of less than 180 degrees with respect to the first cover portion, an end portion of the hinge portion in the circumferential direction of the first arcuate outer edge portion and the second arcuate outer edge portion assumes an arc shape.

3. The soundproofing cover according to claim 1, wherein the hinge portion is configured such that, when the second cover portion is closed with respect to the first cover portion, at least the middle region in the circumferential direction of the first arcuate outer edge portion and the second arcuate outer edge portion is deformed into a protruding shape that protrudes to an outward side from the first cover portion and the second cover portion.

4. The soundproofing cover according to claim 1, wherein a plate thickness of the hinge portion is constant.
